(19) United States
(12) Patent Application Publication
(10) Pub. No.: US 2024/0086225 A1
(43) Pub. Date: Mar. 14, 2024

(54) CONTAINER GROUP SCHEDULING METHODS AND APPARATUSES

(71) Applicant: ALIPAY (HANGZHOU) INFORMATION TECHNOLOGY CO., LTD., Hangzhou (CN)

(72) Inventors: Zhigang Wang, Hangzhou (CN); Longgang Chen, Hangzhou (CN); Tongkai Yang, Hangzhou (CN)

(73) Assignee: ALIPAY (HANGZHOU) INFORMATION TECHNOLOGY CO., LTD., Hangzhou (CN)

(21) Appl. No.: 18/467,061

(22) Filed: Sep. 14, 2023

(30) Foreign Application Priority Data
Sep. 14, 2022 (CN) 202211117315.5

(51) Int. Cl. G06F 9/455

(52) U.S. Cl. CPC G06F 9/45558; G06F 2009/4557

(57) ABSTRACT

A container group scheduling method includes obtaining multiple to-be-scheduled pods from a pod scheduling queue. Equivalence class partitioning on the multiple to-be-scheduled pods is performed to obtain at least one pod set. Each of the at least one pod set is determined as a target pod set. Scheduling processing is performed on the target pod set to bind each pod in the target pod set to a node configured to run the pod. A target schedulable node set corresponding to the target pod set is determined. A correspondence between the target pod set and the target schedulable node set is cached. From the target schedulable node set, a node corresponding to each pod in the target pod set is determined. Each pod in the target pod set is bound to the node corresponding to each pod in the target pod set. The cached correspondence is deleted.

### CROSS-REFERENCE TO RELATED APPLICATIONS

This application claims priority to Chinese Patent Application No. 202211117315.5, filed on Sep. 14, 2022, which is hereby incorporated by reference in its entirety.

### TECHNICAL FIELD

One or more embodiments of this specification relate to the blockchain field, and in particular, to container group scheduling methods and apparatuses.

### BACKGROUND

Container technology refers to lightweight kernel-level operating system-layer virtualization technology. Currently, commonly used container technologies include Docker, Kubernetes, and the like.

Kubernetes is an open-source platform for managing containerized workloads and services. It is portable and extensible, and simplifies declarative configuration and automation. Workloads are applications running on Kubernetes. A Kubernetes cluster is a group of nodes for running workloads. Kubernetes runs workloads by placing containers into pods (container groups) which run on nodes. The nodes contain services needed for running pods. One node can be one virtual machine or physical machine, depending on configurations of a Kubernetes cluster in which the node is located. A pod is a smallest deployable computing unit that can be created and managed in Kubernetes. One pod can encapsulate a group of containers, storage resources and network IP addresses shared by the group of containers, and declarations for managing and controlling container running modes. In Kubernetes, scheduling is to ensure that a pod matches a suitable node, so that the pod runs on the node.

Nowadays, services have different requirements, and fall into a wide range of types. In a large-scale cluster, pods are created or destroyed at all times. Therefore, a growing quantity of pods need to be scheduled. In this case, ensuring stable and highly efficient pod scheduling becomes a basic capability needed by a large-scale cluster.

### SUMMARY

One or more embodiments of this specification provide the following technical solutions:

This specification provides container group scheduling methods, and the methods are applied to a scheduler running on a master node in a container management cluster; the container management cluster includes multiple nodes configured to run pods created in the container management cluster; and the methods include the following: obtaining multiple to-be-scheduled pods from a pod scheduling queue, and performing equivalence class partitioning on the multiple to-be-scheduled pods to obtain at least one pod set; and successively determining each of the at least one pod set as a target pod set, and performing scheduling processing on the target pod set to bind each pod in the target pod set to a node configured to run the pod; where the scheduling processing includes the following: determining a target schedulable node set corresponding to the target pod set, and caching a correspondence between the target pod set and the target schedulable node set; determining, from the target schedulable node set, the node corresponding to each pod in the target pod set, and binding each pod in the target pod set to the node corresponding to the pod; and after each pod in the target pod set is bound to the node corresponding to the pod, deleting the cached correspondence.

This specification further provides container group scheduling apparatuses, and the apparatuses are applied to a scheduler running on a master node in a container management cluster; the container management cluster includes multiple nodes configured to run pods created in the container management cluster; and the apparatuses include the following: an acquisition module, configured to obtain multiple to-be-scheduled pods from a pod scheduling queue, and perform equivalence class partitioning on the multiple pods to obtain at least one pod set; and a scheduling module, configured to successively determine each of the at least one pod set as a target pod set, and perform scheduling processing on the target pod set to bind each pod in the target pod set to a node configured to run the pod; where the scheduling processing includes the following: determining a target schedulable node set corresponding to the target pod set, and caching a correspondence between the target pod set and the target schedulable node set; determining, from the target schedulable node set, the node corresponding to each pod in the target pod set, and binding each pod in the target pod set to the node corresponding to the pod; and after each pod in the target pod set is bound to the node corresponding to the pod, deleting the cached correspondence.

This specification further provides electronic devices, including: a processor; and a memory configured to store instructions executable by the processor; where the processor runs the executable instructions to implement the steps of the method according to any items described above.

This specification further provides computer-readable storage media. Computer instructions are stored on each of the computer-readable storage media, and the instructions are executed by a processor to implement the steps of the method according to any items described above.

In the above-mentioned technical solutions, multiple to-be-scheduled pods can be obtained from a pod scheduling queue, and equivalence class partitioning can be performed on the multiple pods to obtain at least one pod set. Subsequently, each of the at least one pod set can be successively determined as a target pod set, and scheduling processing can be performed on the target pod set to bind each pod in the target pod set to a node configured to run the pod. When scheduling processing is performed, specifically, a target schedulable node set corresponding to the target pod set can be first determined, and a correspondence between the target pod set and the target schedulable node set can be cached; then, from the target schedulable node set, the node corresponding to each pod in the target pod set can be determined, and each pod in the target pod set can be bound to the node corresponding to the pod; and after each pod in the target pod set is bound to the node corresponding to the pod, the cached correspondence between the target pod set and the target schedulable node set can be deleted.

In the above-mentioned method, a correspondence, between a pod set and a schedulable node set, obtained by equivalence class partitioning is re-determined in every container group scheduling procedure, and pods in the pod set are scheduled based on the re-determined correspondence, instead of always performing pod scheduling based on an already stored correspondence between equivalence classes and schedulable nodes. Therefore, it becomes possible to avoid the problems that pods cannot run properly which are caused by scheduling pods to nodes that are no longer schedulable nodes of the pods due to changes in the nodes. Thereby, stable pod scheduling can be ensured.

### BRIEF DESCRIPTION OF DRAWINGS

FIG. 1 is a flowchart of a container group scheduling method according to some example embodiments of this specification;

FIG. 2 is a schematic diagram of a scheduling processing procedure according to some example embodiments of this specification;

FIG. 3 is a schematic diagram of a pod acquisition phase according to some example embodiments of this specification;

FIG. 4 is a schematic diagram of an equivalence class partitioning phase according to some example embodiments of this specification;

FIG. 5 is a schematic diagram of a pod scheduling phase according to some example embodiments of this specification;

FIG. 6 is a schematic diagram of a hardware structure of a device according to some example embodiments of this specification; and

FIG. 7 is a block diagram of a container group scheduling apparatus according to some example embodiments of this specification.

### DESCRIPTION OF EMBODIMENTS

Example embodiments are described in detail here, and examples of the example embodiments are presented in the accompanying drawings. When the following description relates to the accompanying drawings, unless specified otherwise, same numbers in different accompanying drawings represent same or similar elements. Implementations described in the following example embodiments do not represent all implementations consistent with one or more embodiments of this specification, but merely examples of apparatuses and methods that are consistent with some aspects of one or more embodiments of this specification, as described in detail in the appended claims.

It should be noted that, in another embodiment, steps of a corresponding method are not necessarily performed according to a sequence shown and described in this specification. In some other embodiments, the method thereof can include more or fewer steps than those described in this specification. In addition, a single step described in this specification can be broken down into multiple steps for description in another embodiment. However, multiple steps described in this specification can also be combined into a single step for description in another embodiment.

For a Kubernetes cluster, nodes can be classified into a master node (management node) and a worker node (work node). The master node is a manager of the Kubernetes cluster, and services running on the master node include kube-apiserver, kube-scheduler, kube-controller-manager, etcd, and components related to a container network. The worker node is a node bearing a workload in the Kubernetes cluster, and services running on the worker node include a Docker runtime environment, kubelet, kube-proxy, and other optional components.

During pod scheduling, the master node can communicate with the worker node. kube-scheduler on the master node places a pod on a suitable worker node, so that kubelet on the worker node can run the pod.

kube-scheduler is the default scheduler in the Kubernetes cluster. kubelet is a proxy running on each node in the Kubernetes cluster, and can ensure that all containers run in pods. kubelet needs to register with kube-apiserver to work based on a set of PodSpec provided by kube-apiserver. One PodSpec is a YAML or JSON object that describes a pod. kube-apiserver is an application programming interface (API) server in the Kubernetes cluster, and can verify and configure data of API objects, including pods, services, replication controllers, and the like. The API server provides a service for a REST operation and provides a front end for a shared state of the cluster. All other components interact with each other through the front end. A REST API is a basic structure of Kubernetes. Communication between all operations and components as well as external user commands are all REST APIs processed by invoking the API server. Therefore, Kubernetes considers all communication and commands as API objects.

For an unscheduled pod, kube-scheduler selects an optimal node to run the pod. However, containers in pods have different requirements on resources, and the pods also have different requirements. Therefore, before a pod is scheduled to a node, the nodes in the Kubernetes cluster need to be filtered based on these specific scheduling requirements. In the Kubernetes cluster, all nodes that satisfy a scheduling requirement of a pod can be referred to as schedulable nodes of the pod. If no node satisfies the scheduling requirement of this pod, the pod remains in an unscheduled state until kube-scheduler can find a suitable node for this pod.

Further, kube-scheduler first finds all schedulable nodes of a pod from the Kubernetes cluster, and then score these schedulable nodes separately based on a series of functions to select a node with the highest score to run the pod. Subsequently, kube-scheduler can notify kube-apiserver of a scheduling decision that this pod is to be scheduled to the node. This process is called binding the pod to the node. With reference to the above-mentioned content, after the pod is bound to the node, kubelet running on the node can run the pod based on PodSpec provided by kube-apiserver.

However, if the nodes in the Kubernetes cluster need to be filtered for each to-be-scheduled pod to obtain all schedulable nodes, and then the schedulable nodes are scored to select a node with the highest score to run the pod, a large amount of calculation is needed, and consequently pod scheduling efficiency is relatively low.

In related technologies, for each to-be-scheduled pod, an equivalence class of the pod is first determined, and then it is determined whether a correspondence between the equivalence class and a schedulable node is stored to improve pod scheduling efficiency and shorten a pod scheduling delay. If yes, all schedulable nodes corresponding to the equivalence class are scored to select a node with the highest score to run the pod; or if no, the nodes in the Kubernetes cluster are first filtered to obtain all schedulable nodes, then the schedulable nodes are scored to select a node with the highest score to run the pod, and a correspondence between the equivalence class and each of the schedulable nodes is stored, so that the correspondence is subsequently used for pod scheduling.

However, in a large-scale cluster, a running status of a node, resources that a node can provide, and the like may change over time. In this case, if pod scheduling is always performed based on a stored correspondence between equivalence classes and schedulable nodes, a pod cannot properly run, that is, stable pod scheduling cannot be ensured because the pod may be scheduled to a node that is no longer a schedulable node for the pod due to a change.

Therefore, to ensure stable and highly efficient pod scheduling, this specification provides a technical solution for container group scheduling. In this technical solution, multiple to-be-scheduled pods can be obtained from a pod scheduling queue, and equivalence class partitioning can be performed on the multiple pods to obtain at least one pod set. Subsequently, each of the at least one pod set can be successively determined as a target pod set, and scheduling processing can be performed on the target pod set to bind each pod in the target pod set to a node configured to run the pod. When scheduling processing is performed, specifically, a target schedulable node set corresponding to the target pod set can be first determined, and a correspondence between the target pod set and the target schedulable node set can be cached; then, from the target schedulable node set, the node corresponding to each pod in the target pod set can be determined, and each pod in the target pod set can be bound to the node corresponding to the pod; and after each pod in the target pod set is bound to the node corresponding to the pod, the cached correspondence between the target pod set and the target schedulable node set can be deleted.

In specific implementation, for a container management cluster, all to-be-scheduled pods can be stored in a pod scheduling queue in a specific order.

During pod scheduling, multiple to-be-scheduled pods can be obtained from the above-mentioned pod scheduling queue, and equivalence class partitioning can be performed on the multiple pods to obtain at least one pod set. For the pods obtained from the pod scheduling queue, the pods are not subsequently stored in the pod scheduling queue.

When the at least one pod set is obtained, each of the at least one pod set can be successively determined as a target pod set, and scheduling processing can be performed on the target pod set to bind each pod in the target pod set to a node configured to run the pod.

Specifically, all schedulable nodes corresponding to the target pod set can be first determined. These schedulable nodes can be considered as one schedulable node set (which can be referred to as a target schedulable node set). In this case, a correspondence between the target pod set and the target schedulable node set can be cached.

When the target schedulable node set is determined, the node corresponding to each pod in the target pod set (that is, a node that can be configured to run the pod) can be determined from the target schedulable node set, and each pod in the target pod set can be bound to the node corresponding to the pod.

After each pod in the target pod set is bound to the node corresponding to the pod, the cached correspondence between the target pod set and the target schedulable node set can be deleted to avoid subsequent use of the correspondence for pod scheduling.

In the above-mentioned method, a correspondence, between a pod set and a schedulable node set, obtained by equivalence class partitioning is re-determined in every container group scheduling procedure, and pods in the pod set are scheduled based on the re-determined correspondence, instead of always performing pod scheduling based on an already stored correspondence between equivalence classes and schedulable nodes. Therefore, it becomes possible to avoid the problems that pods cannot run properly which are caused by scheduling pods to nodes that are no longer schedulable nodes of the pods due to changes in the nodes. Thereby, stable pod scheduling can be ensured.

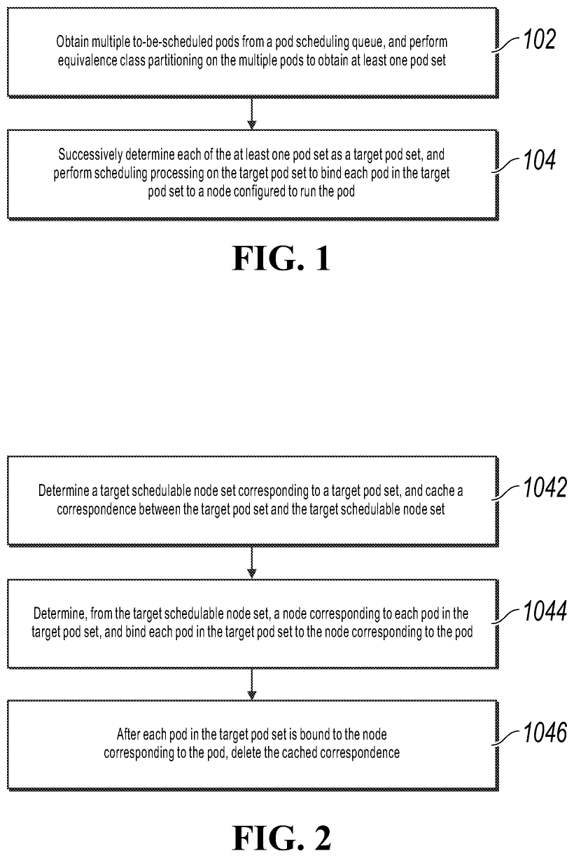

FIG. 1 is a flowchart of a container group scheduling method according to some example embodiments of this specification.

The container group scheduling method can be applied to a scheduler running on a master node in a container management cluster; and the container management cluster includes multiple nodes configured to run pods created in the container management cluster.

In some embodiments, the container management cluster can include a Kubernetes cluster; or the container management cluster can include a Kubernetes-based container management cluster. In this case, the multiple nodes in the container management cluster can specifically include a master node and a worker node, and the scheduler can be specifically a kube-scheduler component running on the master node.

The container group scheduling method can include the following steps.

Step 102: Obtain multiple to-be-scheduled pods from a pod scheduling queue, and perform equivalence class partitioning on the multiple pods to obtain at least one pod set.

In the embodiments, for the container management cluster, all to-be-scheduled pods can be stored in a pod scheduling queue in a specific order.

In actual applications, the sorting order of the pods in the pod scheduling queue can be a temporal order in which the pods are created, or can be a temporal order in which the pods are added to the pod scheduling queue. A specific order can be set based on an actual requirement, and is not limited in this specification. In addition, the to-be-scheduled pods in the pod scheduling queue can specifically exist in forms of pod scheduling requests. That is, scheduling of pods corresponding to the pod scheduling requests can be subsequently implemented based on the pod scheduling requests.

During pod scheduling, multiple to-be-scheduled pods can be obtained from the above-mentioned pod scheduling queue, and equivalence class partitioning can be performed on the multiple pods to obtain at least one pod set. For the pods obtained from the pod scheduling queue, the pods are not subsequently stored in the pod scheduling queue.

It should be noted that, an equivalence class can be used to describe a type of pods that have the same scheduling rule constraint and resource specifications requirement, and is an abstract representation of some factors that can affect schedulable nodes of the pods. In other words, for one equivalence class, schedulable nodes of all pods belonging to the equivalence class are basically the same.

In some embodiments, when the multiple to-be-scheduled pods are obtained from the pod scheduling queue, specifically, multiple to-be-scheduled pods can be obtained from the pod scheduling queue based on a predetermined time period. Or, when a quantity of pods in the pod scheduling queue reaches a predetermined threshold, multiple to-be-scheduled pods can be obtained from the pod scheduling queue.

It should be noted that, a value of the time period can be a fixed time period predetermined by a person skilled in the art based on an actual requirement, or can be a varying time period determined based on a time consumed by each container group scheduling procedure at an end of the container group scheduling procedure. This specification sets no limitation thereto.

Step 104: Successively determine each of the at least one pod set as a target pod set, and perform scheduling processing on the target pod set to bind each pod in the target pod set to a node configured to run the pod.

In the embodiments, when the at least one pod set is obtained, the at least one pod set can be traversed, and scheduling processing can be performed on one pod set obtained each time, so as to bind each pod in the pod set to a node configured to run the pod. That is, each of the at least one pod set can be successively determined as a target pod set, and scheduling processing can be performed on the target pod set to bind each pod in the target pod set to a node configured to run the pod.

For example, assuming that five to-be-scheduled pods (which are respectively pod 1, pod 2, pod 3, pod 4, and pod 5) are obtained from the pod scheduling queue, two pod sets are obtained after equivalence class partitioning is performed on the five pods, and the two pod sets are pod set 1 (including pod 1 and pod 3) and pod set 2 (including pod 2, pod 4, and pod 5). By traversing the two pod sets, pod set 1 can be first determined as a target pod set, and scheduling processing can be performed on pod set 1, so that pod 1 is bound to a node configured to run pod 1 and pod 3 is bound to a node configured to run pod 3; and then pod set 2 can be determined as a target pod set, and scheduling processing can be performed on pod set 2, so that pod 2 is bound to a node configured to run pod 2, pod 4 is bound to a node configured to run pod 4, and pod 5 is bound to a node configured to run pod 5.

Specifically, FIG. 2 is a schematic diagram of a scheduling processing procedure according to some example embodiments of this specification.

For the target pod set mentioned above, performing scheduling processing on the target pod set can include the following steps.

Step 1042: Determine a target schedulable node set corresponding to the target pod set, and cache a correspondence between the target pod set and the target schedulable node set.

In the embodiments, all schedulable nodes corresponding to the target pod set can be first determined. These schedulable nodes can be considered as one schedulable node set (which can be referred to as a target schedulable node set). In this case, a correspondence between the target pod set and the target schedulable node set can be cached.

Step 1044: Determine, from the target schedulable node set, the node corresponding to each pod in the target pod set, and bind each pod in the target pod set to the node corresponding to the pod.

In the embodiments, when the target schedulable node set is determined, the node corresponding to each pod in the target pod set (that is, the node that can be configured to run the pod) can be determined from the target schedulable node set, and each pod in the target pod set can be bound to the node corresponding to the pod.

Step 1046: After each pod in the target pod set is bound to the node corresponding to the pod, delete the cached correspondence.

In the embodiments, after each pod in the target pod set is bound to the node corresponding to the pod, the cached correspondence between the target pod set and the target schedulable node set can be deleted to avoid subsequent use of the correspondence for pod scheduling.

Still using pod set 1 mentioned above as an example, when scheduling processing is performed on pod set 1, specifically, schedulable node set 1 (assuming that node M, node N, and node X are included) corresponding to pod set 1 can be first determined, and a correspondence between pod set 1 and schedulable node set 1 can be cached. Subsequently, a node (which is assumed to be node N) corresponding to pod 1 can be determined from schedulable node set 1, and pod 1 can be bound to node N; and a node (which is assumed to be node X) corresponding to pod 2 can be determined from schedulable node set 1, and pod 2 can be bound to node X. After scheduling of pod 1 and pod 2 is completed, the cached correspondence between pod set 1 and schedulable node set 1 can be deleted.

The following provides a detailed description by dividing the above-mentioned container group scheduling method into three phases: pod acquisition, equivalence class partitioning, and pod scheduling.

(1) Pod Acquisition

In the embodiments, for the container management cluster, all to-be-scheduled pods can be stored in a pod scheduling queue in a specific order.

During pod scheduling, multiple to-be-scheduled pods can be first obtained from the above-mentioned pod scheduling queue. For the pods obtained from the pod scheduling queue, the pods are not subsequently stored in the pod scheduling queue.

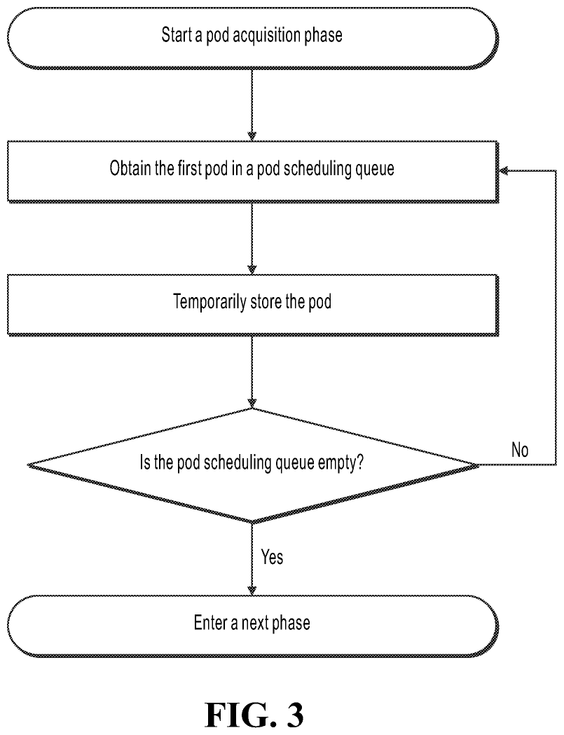

A procedure shown in FIG. 3 is used as an example. In the pod acquisition phase, the current first pod in the pod scheduling queue can be first obtained, and the pod can be temporarily stored; and then it can be determined whether the pod scheduling queue is empty. If the pod scheduling queue is not empty, the current first pod in the pod scheduling queue can be further obtained, and the pod can be temporarily stored, and so on. If the pod scheduling queue is empty, it indicates that all the pods in the pod scheduling queue have been obtained, and therefore a next phase (that is, the equivalence class partitioning phase) can be entered.

(2) Equivalence Class Partitioning

In the embodiments, when multiple to-be-scheduled pods can be obtained from the above-mentioned pod scheduling queue, equivalence class partitioning can be performed on the multiple pods to obtain at least one pod set.

In some embodiments, the multiple pods can be traversed, and classification processing can be performed on one pod obtained each time, so that equivalence class partitioning can be performed on the multiple pods to obtain at least one pod set. That is, each of the multiple pods can be successively determined as a target pod, and classification processing can be performed on the target pod so as to perform equivalence class partitioning on the multiple pods to obtain the at least one pod set.

For the above-mentioned target pod, when classification processing is performed on the target pod, specifically, feature data of the target pod can be first obtained, a classification index corresponding to the target pod can be calculated based on the feature data of the target pod, and then it can be determined whether a pod set corresponding to the classification index exists. If the pod set corresponding to the classification index exists, the target pod can be added to the pod set; or if the pod set corresponding to the classification index does not exist, the pod set can be created and the target pod can be added to the pod set.

In some embodiments, the feature data can include at least one or a combination of multiple of general attribute information, resource specifications information, and a scheduling rule. The general attribute information can include kind, priority, quotaID, and other fields corresponding to the pod, for example, fields such as kind, priority, and quotaID in a pod scheduling request corresponding to the pod. The resource specifications information can include quantities of resources needed by the pod, such as CPU, memory, disk, and GPU resources. The scheduling rule can include rules used for pod scheduling, such as nodeSelector, tolerations, and affinity.

Further, in some embodiments, the feature data can include the general attribute information, the resource specifications information, and the scheduling rule. In this case, when the classification index corresponding to the target pod is calculated based on the feature data of the target pod, specifically, a hash value of each of the general attribute information, the resource specifications information, and the scheduling rule of the target pod can be separately calculated; and the hash value of the general attribute information, the hash value of the resource specifications information, and the hash value of the scheduling rule can be spliced, and a hash value obtained through splicing can be determined as the classification index corresponding to the target pod.

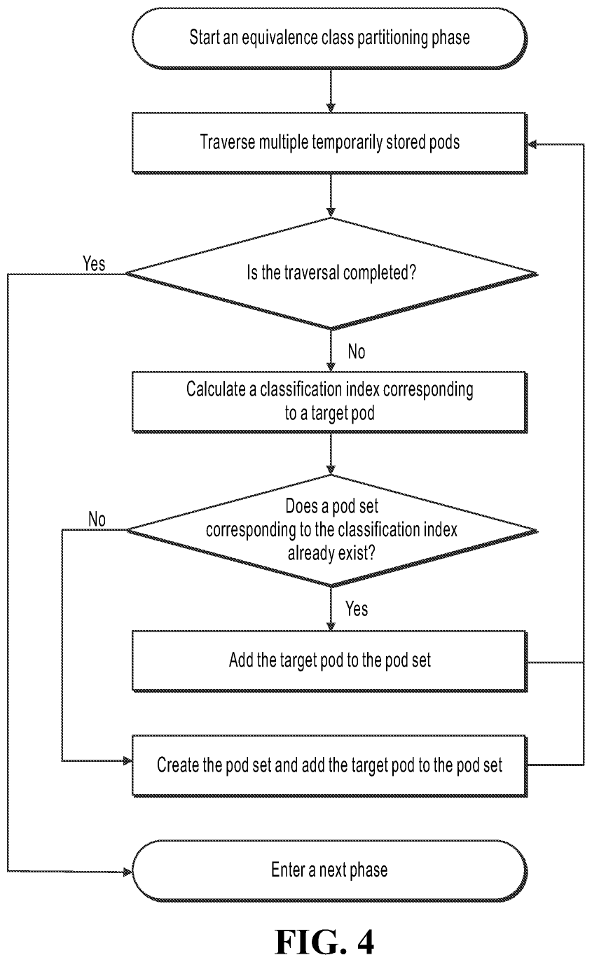

A procedure in FIG. 4 is used as an example. In the equivalence class partitioning phase, the multiple temporarily stored pods can be traversed, and when it is determined that the traversal is completed, a next phase (that is, the pod scheduling phase) is entered; or when it is determined that the traversal is not completed, a currently obtained pod is determined as a target pod. A classification index corresponding to the target pod is first calculated, and then it is determined whether a pod set corresponding to the classification index already exists. If the pod set exists, the target pod can be added to the pod set; or if the pod set does not exist, the pod set can be created, and the target pod can be added to the pod set.

(3) Pod Scheduling

In the embodiments, for a target pod set determined from the at least one pod set obtained by performing equivalence class partitioning, all schedulable nodes corresponding to the target pod set can be first determined. These schedulable nodes can be considered as one schedulable node set (which can be referred to as a target schedulable node set). In this case, a correspondence between the target pod set and the target schedulable node set can be cached.

In some embodiments, when the target schedulable node set corresponding to the target pod set is determined, specifically, a master pod can be determined from the target pod set, so as to determine a schedulable node set corresponding to the master pod, and determine the schedulable node set corresponding to the master pod as the target schedulable node set corresponding to the target pod set.

In actual applications, the master pod can be the first pod added to the target pod set.

Further, in some embodiments, when the schedulable node set corresponding to the master pod is determined, specifically, a node that is incapable of running the master pod can be filtered out from the nodes included in the container management cluster, and remaining nodes can be determined as nodes in the schedulable node set corresponding to the master pod.

In addition, when the remaining nodes are determined as the nodes in the schedulable node set corresponding to the master pod, specifically, the remaining nodes can be first scored, and the remaining nodes can be sorted in order of values of scores. For example, running scoring can be performed on the remaining nodes with respect to the master pod, and the remaining nodes can be sorted in order of values of running scores. Subsequently, N (N represents a predetermined quantity) nodes with the highest running score can be determined based on a sorting result, and the N nodes can be determined as the nodes in the schedulable node set corresponding to the master pod.

In the embodiments, when the target schedulable node set is determined, a node corresponding to each pod in the target pod set (that is, a node that can be configured to run the pod) can be determined from the target schedulable node set, and each pod in the target pod set can be bound to the node corresponding to the pod.

In some embodiments, when the node corresponding to each pod in the target pod set is determined from the target schedulable node set, and each pod in the target pod set is bound to the node corresponding to the pod, specifically, pods in the target pod set can be traversed, and binding processing can be performed on one pod obtained each time, so that the pod to can be bound to the node corresponding to the pod. That is, each pod in the target pod set can be successively determined as a target pod, and binding processing can be performed on the target pod to bind the target pod to a node corresponding to the target pod.

For the target pod, when binding processing is performed on the target pod, specifically, a node that has the highest running score in the target schedulable node set can be determined as the node corresponding to the target pod, and the target pod can be bound to the node corresponding to the target pod.

Or, considering that there is a certain difference between pods belonging to the same equivalence class, it is possible that nodes most suitable for running these pods are different. Specifically, a node that has the highest running score in the target schedulable node set and that satisfies a resource requirement of the target pod can be determined as the node corresponding to the target pod, and the target pod can be bound to the node corresponding to the target pod.

It can be learned that, the schedulable node set corresponding to the master pod determined from the target pod set is determined as the target schedulable node set corresponding to the target pod set, and each pod in the target pod set is bound to the node that corresponds to the pod and that is determined from the target schedulable node set. Such practice can avoid first filtering the nodes in the container group management cluster to obtain all schedulable nodes for each pod in the target pod set, and then scoring these schedulable nodes to select the node with the highest score to run the node. Therefore, an amount of calculation can be reduced, pod scheduling efficiency can be improved, and a pod scheduling delay can be shortened.

In the embodiments, after each pod in the target pod set is bound to the node corresponding to the pod, the cached correspondence between the target pod set and the target schedulable node set can be deleted to avoid subsequent use of the correspondence for pod scheduling.

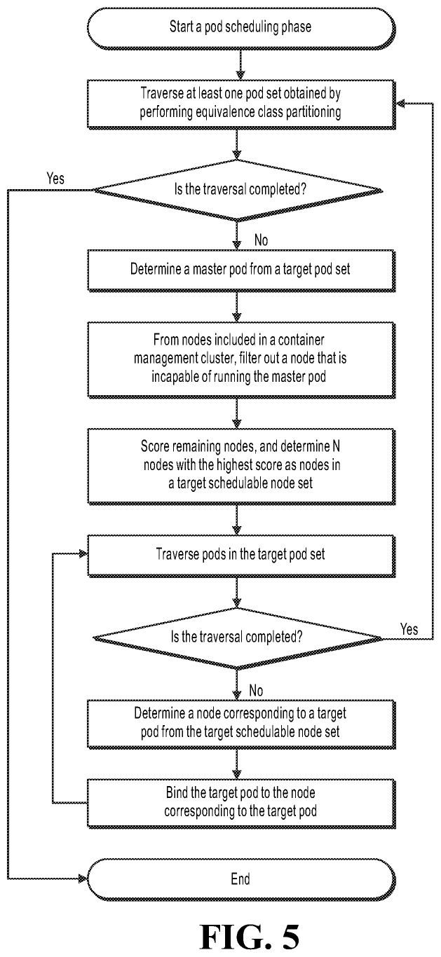

A procedure shown in FIG. 5 is used as an example. In the pod scheduling phase, the at least one pod set obtained by performing equivalence class partitioning can be traversed first, and when it is determined that the traversal is completed, the current container group scheduling procedure is ended; or when it is determined that the traversal is not completed, a currently obtained pod set is determined as a target pod set, and a master pod is determined from the target pod set. As such, a node that is incapable of running the master pod can be filtered out from the nodes included in the container management cluster, then remaining nodes can be scored, and the remaining nodes can be sorted in order of values of scores. Subsequently, N nodes with the highest score can be determined based on a sorting result, and the N nodes can be determined as nodes in a target schedulable node set corresponding to the target pod set.

Then, pods in the target pod set can be traversed, and when it is determined that the traversal is completed, the at least one pod set continues to be traversed, and so on; or when it is determined that the traversal is not completed, a currently obtained pod is determined as a target pod, a node corresponding to the target pod is determined from the target schedulable node set, and the target pod is bound to the node corresponding to the target pod.

In the above-mentioned technical solutions, multiple to-be-scheduled pods can be obtained from a pod scheduling queue, and equivalence class partitioning can be performed on the multiple pods to obtain at least one pod set. Subsequently, each of the at least one pod set can be successively determined as a target pod set, and scheduling processing can be performed on the target pod set to bind each pod in the target pod set to a node configured to run the pod. When scheduling processing is performed, specifically, a target schedulable node set corresponding to the target pod set can be first determined, and a correspondence between the target pod set and the target schedulable node set can be cached; then, from the target schedulable node set, the node corresponding to each pod in the target pod set can be determined, and each pod in the target pod set can be bound to the node corresponding to the pod; and after each pod in the target pod set is bound to the node corresponding to the pod, the cached correspondence between the target pod set and the target schedulable node set can be deleted.

In the above-mentioned method, a correspondence, between a pod set and a schedulable node set, obtained by equivalence class partitioning is re-determined in every container group scheduling procedure, and pods in the pod set are scheduled based on the re-determined correspondence, instead of always performing pod scheduling based on an already stored correspondence between equivalence classes and schedulable nodes. Therefore, it becomes possible to avoid the problems that pods cannot run properly which are caused by scheduling pods to nodes that are no longer schedulable nodes of the pods due to changes in the nodes. Thereby, stable pod scheduling can be ensured.

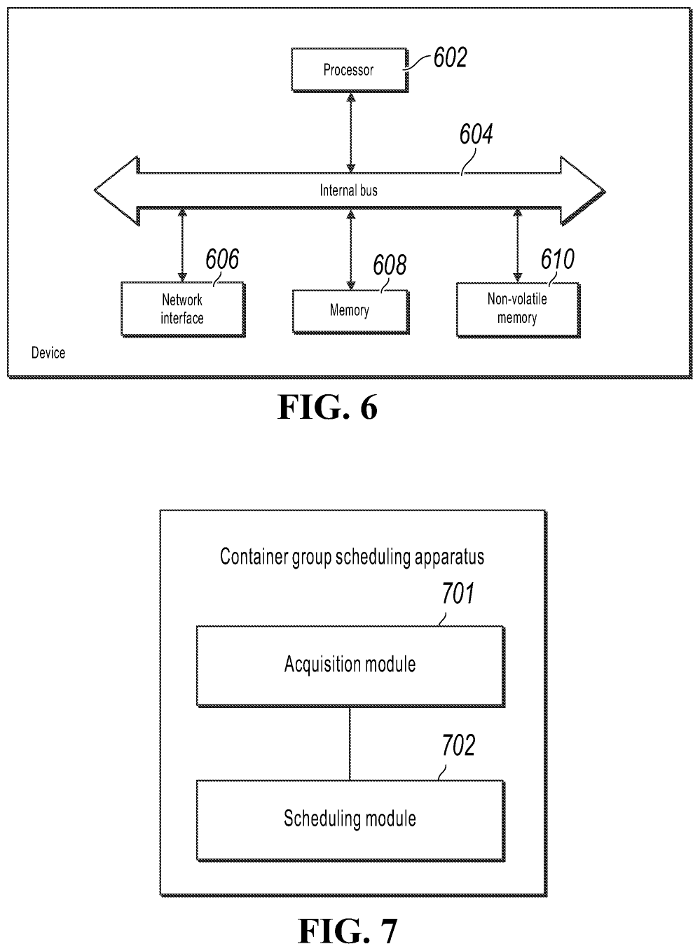

FIG. 6 is a schematic diagram of a hardware structure of a device according to some example embodiments of this specification.

As shown in FIG. 6, at a hardware level, the device includes a processor 602, an internal bus 604, a network interface 606, a memory 608, and a non-volatile memory 610, and certainly can further include hardware needed by another service. One or more embodiments of this specification can be implemented in a software-based way, for example, the processor 602 reads a corresponding computer program from the non-volatile memory 610 to the memory 608, and then runs the computer program. Certainly, in addition to a software implementation, one or more embodiments of this specification do not rule out other implementations, such as an implementation of a logic device or a combination of software and hardware. In other words, an execution body of the following processing procedure is not limited to each logical module, and can be hardware or a logic device.

FIG. 7 is a block diagram of a container group scheduling apparatus according to some example embodiments of this specification.

The container group scheduling apparatus can be applied to a scheduler on the device shown in FIG. 6 to implement the technical solutions of this specification. The device can serve as a master node running in a container management cluster. The container management cluster includes multiple nodes configured to run pods created in the container management cluster. The apparatus includes the following: an acquisition module 701, configured to obtain multiple to-be-scheduled pods from a pod scheduling queue, and perform equivalence class partitioning on the multiple pods to obtain at least one pod set; and a scheduling module 702, configured to successively determine each of the at least one pod set as a target pod set, and perform scheduling processing on the target pod set to bind each pod in the target pod set to a node configured to run the pod; where the scheduling processing includes the following: determining a target schedulable node set corresponding to the target pod set, and caching a correspondence between the target pod set and the target schedulable node set; determining, from the target schedulable node set, the node corresponding to each pod in the target pod set, and binding each pod in the target pod set to the node corresponding to the pod; and after each pod in the target pod set is bound to the node corresponding to the pod, deleting the cached correspondence.

In the embodiments, the acquisition module is specifically configured to: obtain the multiple to-be-scheduled pods from the pod scheduling queue based on a predetermined time period; or when a quantity of pods in the pod scheduling queue reaches a predetermined threshold, obtain the multiple to-be-scheduled pods from the pod scheduling queue.

In the embodiments, the acquisition module is specifically configured to: successively determine each of the multiple pods as a target pod, and perform classification processing on the target pod so as to perform equivalence class partitioning on the multiple pods to obtain the at least one pod set; where the classification processing includes the following: obtaining feature data of the target pod, and calculating, based on the feature data, a classification index corresponding to the target pod; determining whether a pod set corresponding to the classification index exists; and if the pod set corresponding to the classification index exists, adding the target pod to the pod set; or if the pod set corresponding to the classification index does not exist, creating the pod set and adding the target pod to the pod set.

In the embodiments, the feature data include at least one or a combination of multiple of general attribute information, resource specifications information, and a scheduling rule.

In the embodiments, the feature data include the general attribute information, the resource specifications information, and the scheduling rule; and the acquisition module is specifically configured to: separately calculate a hash value of each of the general attribute information, the resource specifications information, and the scheduling rule of the target pod; and splice the hash value of the general attribute information, the hash value of the resource specifications information, and the hash value of the scheduling rule, and determine a hash value obtained through splicing as the classification index corresponding to the target pod.

In the embodiments, the scheduling module is specifically configured to: determine a master pod from the target pod set; and determine a schedulable node set corresponding to the master pod, and determine the schedulable node set as the target schedulable node set corresponding to the target pod set.

In the embodiments, the master pod is the first pod added to the target pod set.

In the embodiments, the scheduling module is specifically configured to: filter out, from the nodes included in the container management cluster, a node that is incapable of running the master pod, and determine remaining nodes as nodes in the schedulable node set corresponding to the master pod.

In the embodiments, the scheduling module is specifically configured to: perform running scoring on the remaining nodes with respect to the master pod, and sort the remaining nodes in order of values of running scores; and determine, based on a sorting result, a predetermined quantity of nodes with the highest running score, and determine the predetermined quantity of nodes as the nodes in the schedulable node set corresponding to the master pod.

In the embodiments, the scheduling module is specifically configured to: successively determine each pod in the target pod set as a target pod, and perform binding processing on the target pod to bind the target pod to a node corresponding to the target pod; and the binding processing includes the following: determining a node that has the highest running score in the target schedulable node set as the node corresponding to the target pod, and binding the target pod to the node corresponding to the target pod.

In the embodiments, the scheduling module is specifically configured to: successively determine each pod in the target pod set as a target pod, and perform binding processing on the target pod to bind the target pod to a node corresponding to the target pod; and the binding processing includes the following: determining a node that has the highest running score in the target schedulable node set and that satisfies a resource requirement of the target pod as the node corresponding to the target pod, and binding the target pod to the node corresponding to the target pod.

In the embodiments, the container management cluster includes a Kubernetes cluster or a Kubernetes-based container management cluster.

The apparatus embodiments basically correspond to the method embodiments. Therefore, for related parts, references can be made to partial descriptions in the method embodiments.

The described apparatus embodiments are merely illustrative. The modules described as separate parts may or may not be physically separated, and parts displayed as modules may or may not be physical modules, that is, may be located in a same place or may be distributed to multiple network modules. Some or all of the modules may be selected according to actual requirements to implement the objectives of the technical solutions of this specification.

The systems, apparatuses, modules, or units illustrated in the above-mentioned embodiments can be implemented by using a computer chip or an entity, or can be implemented by using a product having a certain function. A typical implementation device is a computer, and a specific form of the computer can be a personal computer, a laptop computer, a cellular phone, a camera phone, a smartphone, a personal digital assistant, a media player, a navigation device, an e-mail sending and receiving device, a game console, a tablet computer, a wearable device, or any combination of several of these devices.

In a typical configuration, the computer includes one or more central processing units (CPUs), an input/output interface, a network interface, and a memory.

The memory can include a non-persistent memory, a random access memory (RAM), and/or a non-volatile memory in a computer-readable medium, for example, a read-only memory (ROM) or a flash read-only memory (flash RAM). The memory is an example of the computer-readable medium.

The computer-readable medium includes persistent, non-persistent, movable, and unmovable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD), or another optical storage, a cassette, a disk memory, a quantum memory, a graphene-based storage medium, another magnetic storage device, or any other non-transmission medium. The computer storage medium can be configured to store information that can be accessed by a computing device. As described in this specification, the computer-readable medium does not include computer-readable transitory media (transitory media) such as a modulated data signal and a carrier.

It should be further noted that, the terms “include”, “comprise”, or their any other variants are intended to cover a non-exclusive inclusion, so a process, a method, a product, or a device that includes a list of elements not only includes those elements but also includes other elements which are not expressly listed, or further includes elements inherent to such a process, method, product, or device. Without more constraints, an element preceded by “includes a . . . ” does not preclude the existence of additional identical elements in the process, method, product, or device that includes the element.

Specific embodiments of this specification are described above. Other embodiments fall within the scope of the appended claims. In some situations, the actions or steps described in the claims can be performed in an order different from the order in the embodiments and the desired results can still be achieved. In addition, the process depicted in the accompanying drawings does not necessarily need a particular execution order to achieve the desired results. In some implementations, multi-tasking and concurrent processing are feasible or can be advantageous.

The terms used in one or more embodiments of this specification are merely used for an objective of describing a specific embodiment, and are not intended to limit one or more embodiments of this specification. The terms “a”, “said”, and “the” of singular forms used in the one or more embodiments and the appended claims of this specification are also intended to include plural forms, unless otherwise specified in the context clearly. It should also be understood that the term “and/or” used here refers to and includes any or all possible combinations of one or more associated listed items.

It should be understood that, although the terms “first”, “second”, “third”, and the like may be used in one or more embodiments of this specification to describe various information, the information should not be limited to these terms. These terms are only used to distinguish the same type of information from each other. For example, without departing from the scope of one or more embodiments of this specification, “first information” may also be referred to as “second information”, and similarly, “second information” may also be referred to as “first information”. Depending on the context, for example, the term “if” used here can be interpreted as “in a case that . . . ”, “when . . . ”, or “in response to determining”.

The above-mentioned descriptions are merely example embodiments of one or more embodiments of this specification, and are not intended to limit one or more embodiments of this specification. Any modification, equivalent replacement, or improvement made in the spirit and principle of one or more embodiments of this specification shall fall within the claimed protection scope of one or more embodiments of this specification.

What is claimed is:

1. A computer-implemented method for container group scheduling applied to a scheduler running on a master node in a container management cluster, wherein the container management cluster comprises multiple nodes configured to run pods created in the container management cluster, comprising:
obtaining multiple to-be-scheduled pods from a pod scheduling queue;
performing equivalence class partitioning on the multiple to-be-scheduled pods to obtain at least one pod set;
successively determining each of the at least one pod set as a target pod set; and
performing scheduling processing on the target pod set to bind each pod in the target pod set to a node configured to run the pod, wherein the scheduling processing comprises:
determining a target schedulable node set corresponding to the target pod set;
caching, as cached correspondence, a correspondence between the target pod set and the target schedulable node set;
determining, from the target schedulable node set, a node corresponding to each pod in the target pod set;
binding each pod in the target pod set to the node corresponding to each pod in the target pod set; and
deleting the cached correspondence.

2. The computer-implemented method of claim 1, obtaining multiple to-be-scheduled pods from a pod scheduling queue, comprises:
obtaining the multiple to-be-scheduled pods from the pod scheduling queue based on a predetermined time period; or
when a quantity of pods in the pod scheduling queue reaches a predetermined threshold, obtaining the multiple to-be-scheduled pods from the pod scheduling queue.

3. The computer-implemented method of claim 1, wherein performing equivalence class partitioning on the multiple to-be-scheduled pods to obtain at least one pod set, comprises:
successively determining each of the multiple to-be-scheduled pods as a target pod;
performing classification processing on the target pod to perform equivalence class partitioning on the multiple to-be-scheduled pods to obtain the at least one pod set, wherein the classification processing comprises:
obtaining feature data of the target pod, and calculating, based on the feature data, a classification index corresponding to the target pod; and
determining whether a pod set corresponding to the classification index exists.

4. The computer-implemented method of claim 3, wherein:
if the pod set corresponding to the classification index exists, adding the target pod to the pod set; or
if the pod set corresponding to the classification index does not exist, creating the pod set and adding the target pod to the pod set.

5. The computer-implemented method of claim 4, wherein the feature data comprises at least one or a combination of multiples of general attribute information, resource specifications information, and a scheduling rule.

6. The computer-implemented method of claim 5, wherein the feature data comprises the general attribute information, the resource specifications information, and the scheduling rule.

7. The computer-implemented method of claim 6, wherein calculating, based on the feature data, a classification index corresponding to the target pod, comprises:
separately calculating a hash value of each of the general attribute information, the resource specifications information, and the scheduling rule of the target pod; and
splicing the hash value of the general attribute information, the hash value of the resource specifications information, and the hash value of the scheduling rule, and determining a hash value obtained through splicing as the classification index corresponding to the target pod.

8. The computer-implemented method of claim 1, wherein determining a target schedulable node set corresponding to the target pod set, comprises:
determining a master pod from the target pod set;
determining a schedulable node set corresponding to the master pod; and
determining the schedulable node set as the target schedulable node set corresponding to the target pod set.

9. The computer-implemented method of claim 8, wherein the master pod is a first pod added to the target pod set.

10. The computer-implemented method of claim 8, wherein the determining a schedulable node set corresponding to the master pod, comprises:
filtering out, from the nodes comprised in the container management cluster, a node that is incapable of running the master pod; and
determining remaining nodes as nodes in the schedulable node set corresponding to the master pod.

11. The computer-implemented method of claim 10, wherein the determining remaining nodes as nodes in the schedulable node set corresponding to the master pod, comprises:
performing running scoring on remaining nodes with respect to the master pod; and
sorting the remaining nodes in order of values of running scores.

12. The computer-implemented method of claim 11, comprising:
determining, based on a sorting result, a predetermined quantity of nodes with a highest running score; and
determining the predetermined quantity of nodes as the nodes in the schedulable node set corresponding to the master pod.

13. The computer-implemented method of claim 11, wherein binding each pod in the target pod set to corresponding to each pod in the target pod set, comprises:
successively determining each pod in the target pod set as a target pod; and
performing binding processing on the target pod to bind the target pod to a node corresponding to the target pod.

14. The computer-implemented method of claim 13, wherein the binding processing, comprises:
determining a node that has a highest running score in the target schedulable node set as the node corresponding to the target pod; and
binding the target pod to the node corresponding to the target pod.

15. The computer-implemented method of claim 13, wherein determining, from the target schedulable node set, the node corresponding to each pod in the target pod set, comprises:
successively determining each pod in the target pod set as a target pod.

16. The computer-implemented method of claim 15, comprising:
performing binding processing on the target pod to bind the target pod to a node corresponding to the target pod.

17. The computer-implemented method of claim 14, wherein the binding processing, comprises:
determining a node that has a highest running score in the target schedulable node set and that satisfies a resource requirement of the target pod as the node corresponding to the target pod; and
binding the target pod to the node corresponding to the target pod.

18. The computer-implemented method of claim 1, wherein the container management cluster comprises a Kubernetes cluster or a Kubernetes-based container management cluster.

19. A non-transitory, computer-readable medium storing one or more instructions executable by a computer system to perform one or more operations for container group scheduling applied to a scheduler running on a master node in a container management cluster, wherein the container management cluster comprises multiple nodes configured to run pods created in the container management cluster, comprising:
obtaining multiple to-be-scheduled pods from a pod scheduling queue;
performing equivalence class partitioning on the multiple to-be-scheduled pods to obtain at least one pod set;
successively determining each of the at least one pod set as a target pod set; and
performing scheduling processing on the target pod set to bind each pod in the target pod set to a node configured to run the pod, wherein the scheduling processing comprises:
determining a target schedulable node set corresponding to the target pod set;
caching, as cached correspondence, a correspondence between the target pod set and the target schedulable node set;
determining, from the target schedulable node set, a node corresponding to each pod in the target pod set;
binding each pod in the target pod set to the node corresponding to each pod in the target pod set; and
deleting the cached correspondence.

20. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations for container group scheduling applied to a scheduler running on a master node in a container management cluster, wherein the container management cluster comprises multiple nodes configured to run pods created in the container management cluster, comprising:
obtaining multiple to-be-scheduled pods from a pod scheduling queue;
performing equivalence class partitioning on the multiple to-be-scheduled pods to obtain at least one pod set;
successively determining each of the at least one pod set as a target pod set; and
performing scheduling processing on the target pod set to bind each pod in the target pod set to a node configured to run the pod, wherein the scheduling processing comprises:
determining a target schedulable node set corresponding to the target pod set;
caching, as cached correspondence, a correspondence between the target pod set and the target schedulable node set;
determining, from the target schedulable node set, a node corresponding to each pod in the target pod set;
binding each pod in the target pod set to the node corresponding to each pod in the target pod set; and
deleting the cached correspondence.
